(19) United States
(12) Patent Application Publication
(10) Pub. No.: US 2025/0105776 A1
(43) Pub. Date: Mar. 27, 2025

(54) PHOTOVOLTAIC SHINGLES WITH POWER ELECTRONICS AND LOW PROFILE CONNECTORS

(71) Applicant: GAF Energy LLC, Parsippany, NJ (US)

(72) Inventors: Richard Perkins, San Jose, CA (US); Babak Farhangi, Kew Gardens Hills, NY (US); Henry Pham, San Jose, CA (US); Hasib Amin, Parsippany, NJ (US); Lewis Abra, San Francisco, CA (US); Kishan Gondolia, San Jose, CA (US)

(21) Appl. No.: 18/890,454

(22) Filed: Sep. 19, 2024

Related U.S. Application Data
(60) Provisional application No. 63/584,636, filed on Sep. 22, 2023.

(51) Int. Cl. H02S 20/25; E04D 1/30; H02S 40/34

(52) U.S. Cl. CPC H02S 20/25; E04D 1/30; H02S 40/34; E04D 2001/308

(57) ABSTRACT

A system includes a plurality of photovoltaic shingles installed a roof deck, including a first photovoltaic shingle vertically adjacent to a second photovoltaic shingle. Each of the photovoltaic shingles includes a headlap portion, a first side lap portion, a plurality of solar cells, a first electrical connector on the first side lap portion and electrically connected to the solar cells, and a power electronics unit on the first side lap portion and electrically connected to the first electrical connector. The second photovoltaic shingle overlays at least a part of the headlap portion of the first photovoltaic shingle. The first electrical connector of the first photovoltaic shingle is electrically connected to the first electrical connector of the second photovoltaic shingle.

### CROSS-REFERENCE TO RELATED APPLICATION

This application is a Section 111 (a) application relating to and claiming the benefit of commonly-owned, co-pending U.S. Provisional Patent Application Ser. No. 63/584,636, filed Sep. 22, 2023 titled “PHOTOVOLTAIC SHINGLES WITH POWER ELECTRONICS AND LOW PROFILE CONNECTIONS,” the contents of which is incorporated herein by reference in its entirety.

### FIELD OF THE INVENTION

The present invention relates to photovoltaic shingles and, more particularly, photovoltaic shingles with power electronics and low profile connectors.

### BACKGROUND

Photovoltaic systems are installed on building roofs to generate electricity.

### SUMMARY

In some embodiments, a system includes a roof deck; a plurality of photovoltaic shingles installed on a slope of a roof deck, wherein the plurality of photovoltaic shingles includes at least first and second photovoltaic shingles, wherein the first photovoltaic shingle is vertically adjacent to the second photovoltaic shingle, wherein each of the photovoltaic shingles includes: a first end and a second end opposite the first end, a headlap portion extending between the first end and the second end, a first side lap portion located at the first end, a plurality of solar cells, a first electrical connector on the first side lap portion, wherein the first electrical connector is electrically connected to the solar cells, and a power electronics unit on the first side lap portion, wherein the power electronics unit is electrically connected to the first electrical connector, wherein the second photovoltaic shingle overlays at least a part of the headlap portion of the first photovoltaic shingle, and wherein the first electrical connector of the first photovoltaic shingle is electrically connected to the first electrical connector of the second photovoltaic shingle.

In some embodiments, each of the photovoltaic shingles includes a first bussing located proximate to the first end, wherein the first bussing includes a first end electrically connected to the power electronics unit and a second end proximate to the first end of the photovoltaic shingle and electrically connected to the solar cells. In some embodiments, each of the photovoltaic shingles includes a second bussing, wherein the second bussing includes a first end electrically connected to the power electronics unit and a second end proximate to the second end of the photovoltaic shingle and electrically connected to the solar cells. In some embodiments, each of the photovoltaic shingles includes a third bussing, wherein the third bussing includes a first end electrically connected to the power electronics unit and a second end between the first and second ends of the photovoltaic shingles and electrically connected to the solar cells.

In some embodiments, each of the photovoltaic shingles includes a bracket on the first side lap, and wherein the bracket is configured to receive a cover. In some embodiments, the bracket is spaced from the power electronics unit 1 mm to 10 mm. In some embodiments, the power electronics unit is laminated with the first side lap portion. In some embodiments, each of the photovoltaic shingles includes a second side lap portion at the second end. In some embodiments, the plurality of photovoltaic shingles includes a third photovoltaic shingle, and wherein the third photovoltaic shingle is horizontally adjacent to the first photovoltaic shingle.

In some embodiments, the first side lap portion of the third photovoltaic shingle overlays the second side lap portion of the first photovoltaic shingle. In some embodiments, the plurality of photovoltaic shingles includes a fourth photovoltaic shingle, and wherein the fourth photovoltaic shingle is horizontally adjacent to the second photovoltaic shingle, wherein the first side lap portion of the fourth photovoltaic shingle overlays the second side lap portion of the second photovoltaic shingle, and wherein the fourth photovoltaic shingle overlays at least a part of the headlap portion of the third photovoltaic shingle.

In some embodiments, the plurality of photovoltaic shingles includes a fifth photovoltaic shingle, and wherein the fifth photovoltaic shingle is vertically adjacent the third photovoltaic shingle, and wherein the fifth photovoltaic shingle overlays at least a part of the headlap portion of the second photovoltaic shingle, and wherein the first electrical connector of the fifth photovoltaic shingle is electrically connected to the first electrical connector of the second photovoltaic shingle. In some embodiments, the fifth photovoltaic shingle includes a second electrical connector on the second side lap portion thereof, and wherein the second electrical connector is electrically connected to the first electrical connector of the fifth photovoltaic shingle. In some embodiments, the fifth photovoltaic shingle includes a fourth bussing, wherein the fourth bussing includes a first end electrically connected to the first electrical connector and a second end electrically connected to the second electrical connector. In some embodiments, the second electrical bussing of the fifth photovoltaic shingle is electrically connected to the second electrical connector of the fifth photovoltaic shingle. In some embodiments, the second side lap portion of the fifth photovoltaic shingle includes a notch. In some embodiments, the second side lap portion of the fifth photovoltaic shingle overlays the first side lap portion of the fourth photovoltaic shingle. In some embodiments, the second side lap portion overlays the power electronics unit of the fourth photovoltaic shingle. In some embodiments, the power electronics unit includes a housing and power electronics within the housing, and wherein the power electronics includes an optimizer, a bypass diode, system monitoring electronic components, a rapid shutdown device, or electronic communication components.

In some embodiments, a system includes a roof deck; a plurality of photovoltaic shingles installed on a slope of a roof deck, wherein the plurality of photovoltaic shingles includes at least first and second photovoltaic shingles, wherein the first photovoltaic shingle is vertically adjacent to the second photovoltaic shingle, wherein each of the photovoltaic shingles includes: a first end and a second end opposite the first end, a headlap portion extending between the first end and the second end, a first side lap portion located at the first end, a plurality of solar cells, a first electrical connector on the first side lap portion, wherein the first electrical connector is electrically connected to the solar cells, a power electronics unit on the first side lap portion, wherein the power electronics unit is electrically connected to the first electrical connector, wherein the power electronics unit includes an optimizer; a first bussing located proximate to the first end, wherein the first bussing includes a first end electrically connected to the power electronics unit and a second end proximate to the first end of the photovoltaic shingle and electrically connected to the solar cells; a second bussing, wherein the second bussing includes a first end electrically connected to the power electronics unit and a second end proximate to the first end of the photovoltaic shingle and electrically connected to the solar cells, wherein the second photovoltaic shingle overlays at least a part of the headlap portion of the first photovoltaic shingle, wherein the first electrical connector of the first photovoltaic shingle is electrically connected to the first electrical connector of the second photovoltaic shingle.

### BRIEF DESCRIPTION OF THE DRAWINGS

FIGS. 1A and 1B are a top plan view and a side elevational view, respectively, of some embodiments of a photovoltaic shingle;

FIG. 2 is a top plan view of some embodiments of a portion of a roofing system including photovoltaic shingles;

FIG. 3 illustrates some embodiments of a power electronics unit;

FIG. 4 is a top plan view of some embodiments of a portion of a roofing system including photovoltaic shingles and power electronics units;

FIG. 5 is a top plan view of some embodiments of a photovoltaic shingle;

FIG. 6 is a top perspective view of some embodiments of a portion of a roofing system including photovoltaic shingles and power electronics units of FIG. 5;

FIG. 7 is a top plan view of some embodiments of a photovoltaic shingle;

FIG. 8 is a top plan view of some embodiments of a photovoltaic shingle;

FIG. 9 is a top plan view of some embodiments of a roofing system including photovoltaic shingles having the photovoltaic shingles shown in FIG. 8; and

FIG. 10 is a close-up, top plan view of a portion of the roofing system shown in FIG. 9.

### DETAILED DESCRIPTION

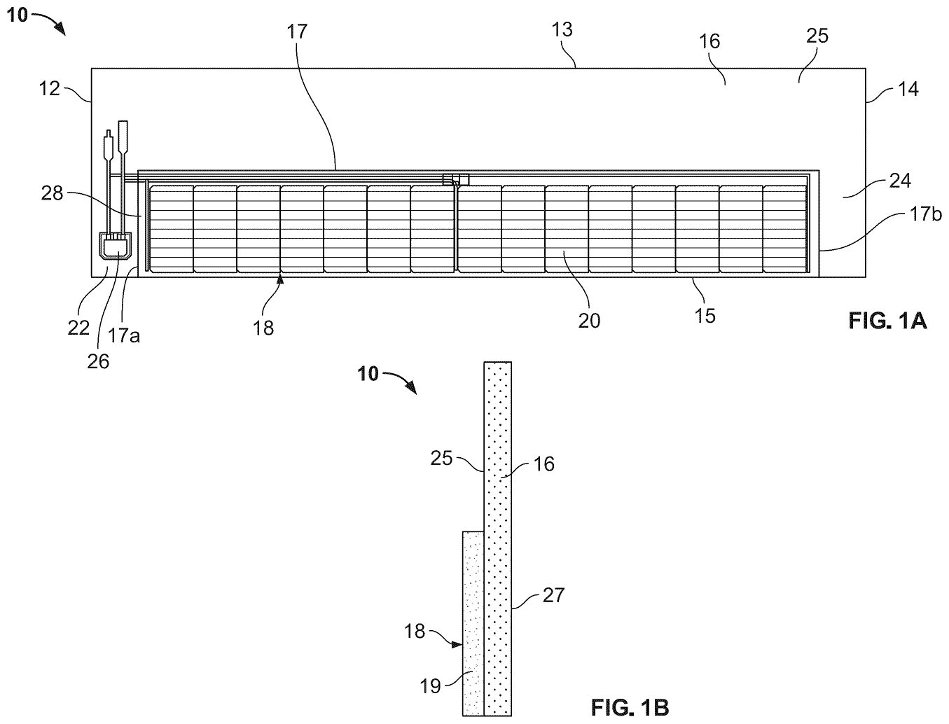

Referring to FIGS. 1A and 1B, in some embodiments, a photovoltaic shingle 10 includes a first end 12, a second end 14 opposite the first end 12, a first edge 13 extending from the first end 12 to the second end 14, and a second edge 15 opposite the first edge 13 and extending from the first end 12 to the second end 14. In some embodiments, the photovoltaic shingle 10 includes a headlap portion 16. In some embodiments, the headlap portion 16 extends from the first end 12 to the second end 14 and from the first edge 13 to a first location 17 between the first edge 13 and the second edge 15. In some embodiments, the photovoltaic shingle 10 includes a reveal portion 18. In some embodiments, the reveal portion 18 includes a photovoltaic layer 19. In some embodiments, the photovoltaic layer 19 includes at least one solar cell 20. In some embodiments, the photovoltaic shingle 10 includes a first side lap portion 22 located at the first end 12. In some embodiments, the first side lap portion 22 includes a width extending from the first end 12 to a second location 17a between the first end 12 and the second end 14. In some embodiments, the first side lap portion 22 includes a length extending from the first location 17 to the second edge 15. In some embodiments, the photovoltaic shingle 10 includes a second side lap portion 24 located at the second end 14. In some embodiments, the second side lap portion 24 includes a width extending from the second end 14 to a third location 17b between the first end 12 and the second end 14. In some embodiments, the second side lap portion 24 includes a length extending from the first location 17 to the second edge 15. In some embodiments, the photovoltaic shingle 10 includes an outer surface 25 and an inner surface 27 opposite the outer surface 25. In some embodiments, the reveal portion 18 extends from the first side lap portion 22 to the second side lap portion 24 and from the second edge 15 to the first location 17. In some embodiments, the photovoltaic shingle 10 is configured to be installed on a building structure. In some embodiments, the photovoltaic shingle 10 is configured to be installed on a roof deck. In some embodiments, at least one junction box 26 is located on the first side lap portion 22. In some embodiments, the at least one junction box 26 includes a plurality of the junction boxes 26. In certain embodiments, other electronic and electrical components may be attached to the first side lap portion 22. In some embodiments, non-limiting examples of such electronic and electrical components include an electrical connector, a rapid shutdown device, an optimizer, and an inverter. In some embodiments, the photovoltaic shingle 10 includes a structure, composition, components, and/or function similar to those of one or more embodiments of the photovoltaic shingles disclosed in PCT International Patent Publication No. WO 2022/051593, Application No. PCT/US2021/049017, published Mar. 10, 2022, titled “Building Integrated Photovoltaic System,” owned by GAF Energy LLC; U.S. Pat. No. 11,251,744 to Bunea et al., issued Feb. 15, 2022, titled “Photovoltaic Shingles and Methods of Installing Same, owned by GAF Energy LLC;” and U.S. Pat. No. 11,870,227, issued Jan. 9, 2024, titled “Building Integrated Photovoltaic System,” owned by GAF Energy LLC, the disclosures of each of which are incorporated by reference herein in their entireties.

In some embodiments, the at least one solar cell 20 includes a plurality of the solar cells 20. In some embodiments, the plurality of solar cells 20 includes two solar cells. In some embodiments, the plurality of solar cells 20 includes three solar cells. In some embodiments, the plurality of solar cells 20 includes four solar cells. In some embodiments, the plurality of solar cells 20 includes five solar cells. In some embodiments, the plurality of solar cells 20 includes six solar cells. In some embodiments, the plurality of solar cells 20 includes seven solar cells. In some embodiments, the plurality of solar cells 20 includes eight solar cells. In some embodiments, the plurality of solar cells 20 includes nine solar cells. In some embodiments, the plurality of solar cells 20 includes ten solar cells. In some embodiments, the plurality of solar cells 20 includes eleven solar cells. In some embodiments, the plurality of solar cells 20 includes twelve solar cells. In some embodiments, the plurality of solar cells 20 includes thirteen solar cells. In some embodiments, the plurality of solar cells 20 includes fourteen solar cells. In some embodiments, the plurality of solar cells 20 includes fifteen solar cells. In some embodiments, the plurality of solar cells 20 includes sixteen solar cells. In some embodiments, the plurality of solar cells 20 includes more than sixteen solar cells.

In some embodiments, the plurality of solar cells 20 is arranged in one row (i.e., one reveal). In another embodiment, the plurality of solar cells 20 is arranged in two rows (i.e., two reveals). In another embodiment, the plurality of solar cells 20 is arranged in three rows (i.e., three reveals). In another embodiment, the plurality of solar cells 20 is arranged in four rows (i.e., four reveals). In another embodiment, the plurality of solar cells 20 is arranged in five rows (i.e., five reveals). In another embodiment, the plurality of solar cells 20 is arranged in six rows (i.e., six reveals). In other embodiments, the plurality of solar cells 20 is arranged in more than six rows. In some embodiments, each of the rows of the plurality of solar cells 20 includes a first end 28 located proximate to the first side lap portion 22.

In some embodiments, a roofing system includes a plurality of the photovoltaic shingles 10 installed on a roof deck. In some embodiments, the roof deck is a steep slope roof deck. As defined herein, a “steep slope roof deck” is any roof deck that is disposed on a roof having a pitch of Y/X, where Y and X are in a ratio of 4:12 to 18:12, where Y corresponds to the “rise” of the roof, and where X corresponds to the “run” of the roof.

In some embodiments, the plurality of photovoltaic shingles 10 is installed directly to the roof deck. In some embodiments, each of the plurality of photovoltaic shingles 10 is installed on the roof deck by a plurality of fasteners. In some embodiments, the plurality of fasteners are installed through the headlap portion 16. In some embodiments, the plurality of fasteners includes a plurality of nails. In some embodiments, the plurality of fasteners includes a plurality of rivets. In some embodiments, the plurality of fasteners includes a plurality of screws. In some embodiments, the plurality of fasteners includes a plurality of staples.

In some embodiments, each of the plurality of photovoltaic shingles 10 is installed on the roof deck by an adhesive. In some embodiments, the adhesive is adhered directly to the roof deck. In some embodiments, the adhesive is adhered to an underlayment. In some embodiments, the underlayment is adhered directly to the roof deck. In some embodiments, the adhesive is located on a rear surface of the photovoltaic shingle 10. In some embodiments, the adhesive includes at least one adhesive strip. In some embodiments, the adhesive includes a plurality of adhesive strips. In some embodiments, the plurality of adhesive strips is arranged intermittently. In some embodiments, the adhesive is located proximate to one edge of the photovoltaic shingle 10. In some embodiments, the adhesive is a peel and stick film sheet. In some embodiments, the peel and stick film sheet includes at least one sheet of film removably attached to the rear surface. In some embodiments, the peel and stick film sheet is composed of EverGuard Freedom HW peel and stick membrane manufactured by GAF. In some embodiments, the adhesive includes polyvinyl butyrate, acrylic, silicone, or polycarbonate. In some embodiments, the adhesive includes pressure sensitive adhesives.

In some embodiments, a first photovoltaic shingle 10 is vertically adjacent to a second photovoltaic shingle 10. In some embodiments, the first photovoltaic shingle 10 overlays at least a part of the headlap portion 16 of the second photovoltaic shingle 10.

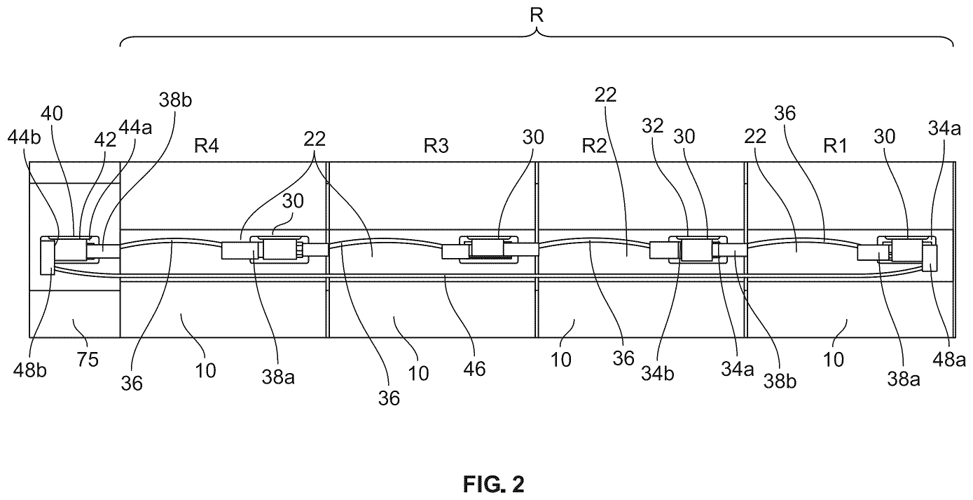

Referring to FIG. 2, in some embodiments, a roofing system includes a plurality of photovoltaic shingles 10 installed on a roof deck 75 in a plurality of rows R. In some embodiments, each of a plurality of the photovoltaic shingles 10 includes a first electrical connector 30. In some embodiments, the first electrical connector 30 is located on the first side lap portion 22. In some embodiments, the first electrical connector 30 is located on the first side lap portion 22 proximate to the first end 28 of the row of solar cells 20. In some embodiments, the first electrical connector 30 is at least partially embedded within the side lap portion 22. In some embodiments, the first electrical connector 30 is attached to an upper surface of the side lap portion 22. In some embodiments, the first electrical connector 30 is attached to the upper surface of the side lap portion 22 by an adhesive. In some embodiments, the first electrical connector 30 is attached to the upper surface of the side lap portion 22 by welding. In some embodiments, the first electrical connector 30 is attached to the upper surface of the side lap portion 22 by heat welding. In some embodiments, the first electrical connector 30 is attached to the upper surface of the side lap portion 22 by ultrasonic welding. In some embodiments, the first electrical connector 30 is attached to the upper surface of the side lap portion 22 by at least one fastener. In some embodiments, the first electrical connector 30 is removably attached to the upper surface of the side lap portion 22.

In some embodiments, the first electrical connector 30 includes a structure, composition, components, and/or function similar to those of one or more embodiments of the electrical connectors disclosed in U.S. Pat. No. 11,843,067 to Nguyen et al., issued Dec. 12, 2023 and titled “Photovoltaic Modules,” and U.S. Pat. No. 12,095,415 to Bunea et al., issued Sep. 17, 2024 and titled “Electrical Components for Photovoltaic Systems,” the contents of each of which are incorporated by reference herein in its entirety.

In some embodiments, the first electrical connector 30 has a thickness of 1 mm to 10 mm. In some embodiments, the first electrical connector 30 has a thickness of 1 mm to 9 mm. In some embodiments, the first electrical connector 30 has a thickness of 1 mm to 8 mm. In some embodiments, the first electrical connector 30 has a thickness of 1 mm to 7 mm. In some embodiments, the first electrical connector 30 has a thickness of 1 mm to 6 mm. In some embodiments, the first electrical connector 30 has a thickness of 1 mm to 5 mm. In some embodiments, the first electrical connector 30 has a thickness of 1 mm to 4 mm. In some embodiments, the first electrical connector 30 has a thickness of 1 mm to 3 mm. In some embodiments, the first electrical connector 30 has a thickness of 1 mm to 2 mm. In some embodiments, the first electrical connector 30 has a thickness of 2 mm to 10 mm. In some embodiments, the first electrical connector 30 has a thickness of 2 mm to 9 mm. In some embodiments, the first electrical connector 30 has a thickness of 2 mm to 8 mm. In some embodiments, the first electrical connector 30 has a thickness of 2 mm to 7 mm. In some embodiments, the first electrical connector 30 has a thickness of 2 mm to 6 mm. In some embodiments, the first electrical connector 30 has a thickness of 2 mm to 5 mm. In some embodiments, the first electrical connector 30 has a thickness of 2 mm to 4 mm. In some embodiments, the first electrical connector 30 has a thickness of 2 mm to 3 mm. In some embodiments, the first electrical connector 30 has a thickness of 3 mm to 10 mm. In some embodiments, the first electrical connector 30 has a thickness of 3 mm to 9 mm. In some embodiments, the first electrical connector 30 has a thickness of 3 mm to 8 mm. In some embodiments, the first electrical connector 30 has a thickness of 3 mm to 7 mm. In some embodiments, the first electrical connector 30 has a thickness of 3 mm to 6 mm. In some embodiments, the first electrical connector 30 has a thickness of 3 mm to 5 mm. In some embodiments, the first electrical connector 30 has a thickness of 3 mm to 4 mm. In some embodiments, the first electrical connector 30 has a thickness of 4 mm to 10 mm. In some embodiments, the first electrical connector 30 has a thickness of 4 mm to 9 mm. In some embodiments, the first electrical connector 30 has a thickness of 4 mm to 8 mm. In some embodiments, the first electrical connector 30 has a thickness of 4 mm to 7 mm. In some embodiments, the first electrical connector 30 has a thickness of 4 mm to 6 mm. In some embodiments, the first electrical connector 30 has a thickness of 4 mm to 5 mm. In some embodiments, the first electrical connector 30 has a thickness of 5 mm to 10 mm. In some embodiments, the first electrical connector 30 has a thickness of 5 mm to 9 mm. In some embodiments, the first electrical connector 30 has a thickness of 5 mm to 8 mm. In some embodiments, the first electrical connector 30 has a thickness of 5 mm to 7 mm. In some embodiments, the first electrical connector 30 has a thickness of 5 mm to 6 mm.

In some embodiments, the first electrical connector 30 has a thickness of 6 mm to 10 mm. In some embodiments, the first electrical connector 30 has a thickness of 6 mm to 9 mm. In some embodiments, the first electrical connector 30 has a thickness of 6 mm to 8 mm. In some embodiments, the first electrical connector 30 has a thickness of 6 mm to 7 mm. In some embodiments, the first electrical connector 30 has a thickness of 7 mm to 10 mm. In some embodiments, the first electrical connector 30 has a thickness of 7 mm to 9 mm. In some embodiments, the first electrical connector 30 has a thickness of 7 mm to 8 mm. In some embodiments, the first electrical connector 30 has a thickness of 8 mm to 10 mm. In some embodiments, the first electrical connector 30 has a thickness of 8 mm to 9 mm. In some embodiments, the first electrical connector 30 has a thickness of 9 mm to 10 mm. In some embodiments, the first electrical connector 30 has a thickness of 1 mm. In some embodiments, the first electrical connector 30 has a thickness of 2 mm. In some embodiments, the first electrical connector 30 has a thickness of 3 mm. In some embodiments, the first electrical connector 30 has a thickness of 4 mm. In some embodiments, the first electrical connector 30 has a thickness of 5 mm. In some embodiments, the first electrical connector 30 has a thickness of 6 mm. In some embodiments, the first electrical connector 30 has a thickness of 7 mm. In some embodiments, the first electrical connector 30 has a thickness of 8 mm. In some embodiments, the first electrical connector 30 has a thickness of 9 mm. In some embodiments, the first electrical connector 30 has a thickness of 10 mm.

In some embodiments, the first electrical connector 30 is electrically connected to the plurality of solar cells 20. In some embodiments, the first electrical connector 30 is electrically connected to the plurality of solar cells 20 by electrical bussing. In some embodiments, the electrical bussing is embedded within the photovoltaic shingle 10.

In some embodiments, the first electrical connector 30 includes a housing 32 and a pair of connectors 34a, 34b. In some embodiments, the connectors 34a, 34b extend from the housing 32. In some embodiments, the connectors 34a, 34b are snap-fit connectors. In some embodiments, the connector 34a is spaced apart from the connector 34b. In some embodiments, the connector 34a is located proximate to one end of the housing 32 and the connector 34b is located proximate to an opposite end of the housing 32. In some embodiments, each of the first electrical connectors 30 is electrically connected to one another by a plurality of electrical jumper wires 36 (also referred to as jumper wires, electrical jumper cables, or jumper cables). In some embodiments, the first electrical connectors 30 are electrically connected to one another in series by the plurality of jumper wires 36. In some embodiments, each of the jumper wires 36 includes a first connector 38a at a first end thereof and a second connector 38b at a second, opposite end thereof. In some embodiments, the first connector 38a of a corresponding one of the jumper wires 36 is connected to a corresponding one of the connector 34b of the housing 32 of the first electrical connector 30. In some embodiments, the first connector 38a of a corresponding one of the jumper wires 36 is preconnected to a corresponding one of the connector 34b of the housing 32 of the first electrical connector 30 of the photovoltaic shingle 10 prior to installation on the roof deck 75. In some embodiments, the second connector 38b of a corresponding one of the jumper wires 36 is connected to a corresponding one of the connector 34a of the housing 32 of the first electrical connector 30 of an adjacent lower one of the plurality of photovoltaic shingles 10 in rows R2, R3, R4.

In some embodiments, the system includes a second electrical connector 40. In some embodiments, the second electrical connector 40 is installed on the roof deck 75. In some embodiments, the second electrical connector 40 is located below row R4. In some embodiments, the second electrical connector 40 is proximate to row R4. In some embodiments, the second electrical connector 40 is adjacent row R4. In some embodiments, the second electrical connector 40 includes a housing 42 and a pair of connectors 44a, 44b. In some embodiments, the connectors 44a, 44b extend from the housing 42. In some embodiments, the second electrical connector 40 has a similar structure and/or function of those of the first electrical connector 30. In some embodiments, a return wire 46 electrically connects the first electrical connector 30 of the photovoltaic shingle 10 in the uppermost row R1 with the second electrical connector 40. In some embodiments, the return wire 46 includes a first connector 48a at a first end thereof and a second connector 48b at a second, opposite end thereof. In some embodiments, the connector 48a of the return wire 46 is connected to the connector 34a of the first electrical connector 30 of the photovoltaic shingle 10 in row R1. In some embodiments, the connector 48b of the return wire 46 is connected to the connector 44b of the second electrical connector 40. In some embodiments, the return wire 46 has a length. In some embodiments, the length of the return wire 46 may vary and be selected by an installer of the system, depending upon the number of rows R of the photovoltaic shingles 10 in the column of the array thereof.

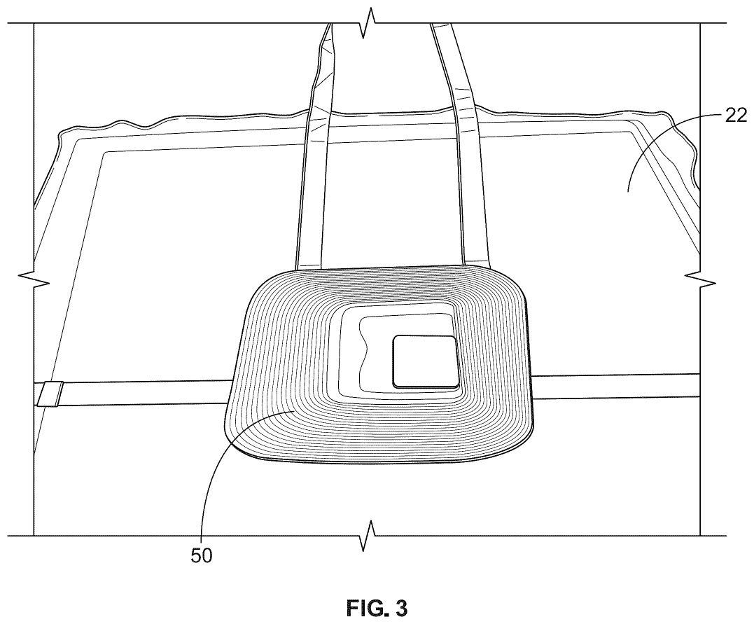

Referring to FIG. 3, in some embodiments, the photovoltaic shingle 10 includes a power electronics unit 50. In some embodiments, the power electronics unit 50 is located on the first side lap portion 22. In some embodiments, the power electronics unit 50 is attached to the first side lap portion 22. In some embodiments, the power electronics unit 50 is laminated with the first side lap portion 22. In some embodiments, the power electronics unit 50 is a DC optimizer PCB. In some embodiments, the power electronics unit 50 may be other PCB's having other functionality, such as bypass diodes, system monitoring electronic components, electronic communication components, rapid shutdown devices, or electronic circuitry assemblies performing one or more functionalities such as power optimization, rapid shutdown, monitoring or communication. In some embodiments, the power electronics unit 50 includes a potted printed circuit board. In some embodiments, the power electronics unit 50 includes a laminated potted printed circuit board. In some embodiments, the potted printed circuit board includes a structure, composition, components, and/or function similar to those of one or more embodiments of the potted printed circuit boards disclosed in U.S. Patent Application Publication No. 2022/0302329, published Sep. 22, 2022, titled “Photovoltaic Module with a Laminated Potted Printed Circuit Board” owned by GAF Energy LLC, the contents of which is incorporated by reference herein in its entirety.

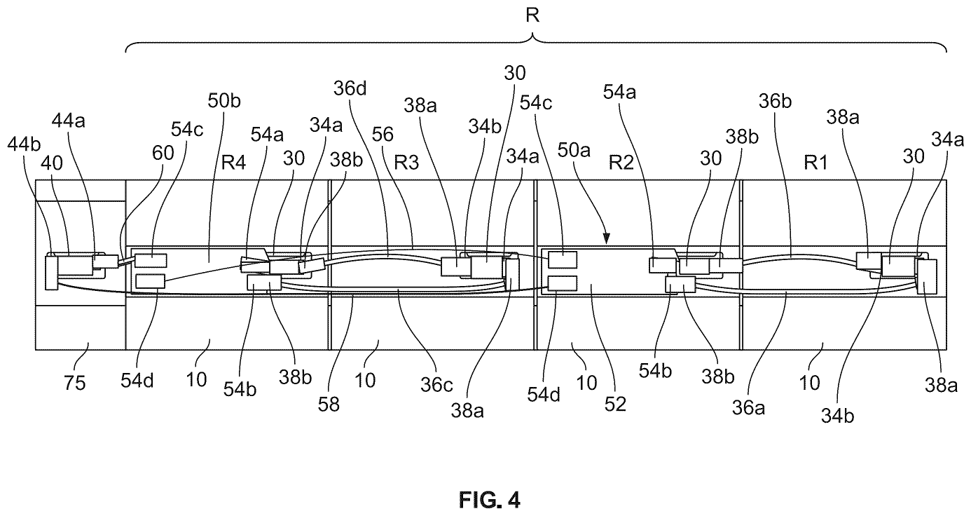

Referring to FIG. 4, in some embodiments, the roofing system illustrated in FIG. 3 and described above may be configured to incorporate a plurality of the power electronics units 50. In some embodiments, the power electronics units 50 are installed once every two rows of the photovoltaic shingles 10. In some embodiments, the power electronics units 50 are installed in every row of the photovoltaic shingles 10. In some embodiments, the power electronics units 50 are installed in some of the rows of the photovoltaic shingles 10. In some embodiments, the power electronics unit 50 includes a housing 52. In some embodiments, the housing 52 is composed of plastic. In some embodiments, the housing is composed of metal. In some embodiments, power electronics are sealed within the housing 52. In some embodiments, the power electronics unit 50 includes four terminals 54a, 54b, 54c, 54d. In some embodiments, each of the terminals 54a-d is a bulkhead terminal. In some embodiments, the power electronics unit 50 may include less than four of the terminals 54a-d. In some embodiments, the power electronics unit 50 may include more than four of the terminals 54a-d.

In some embodiments, a first power electronics unit 50a is installed on the photovoltaic shingle 10 in row R2. In some embodiments, the first power electronics unit 50a is connected to the first electrical connector 30 of the photovoltaic shingle 10 in row R2. In some embodiments, the terminal 54a of the first power electronics unit 50a is connected to connector 34a of the first electrical connector 30 of the photovoltaic shingle 10 in row R2. In some embodiments, the second connector 38b of jumper wire 36a is connected to the terminal 54b of the first power electronics unit 50a, while the first connector 38a of the jumper wire 36a is connected to the connector 34a of the first electrical connector 30 of the photovoltaic shingle 10 in row R1. In some embodiments, the second connector 38b of jumper wire 36b is connected to the first connector 34a of the connector 30 in row R2, while the first connector 38a of the jumper wire 36b is connected to the second connector 34b of the connector 30 in row R1.

In some embodiments, a second power electronics unit 50b is installed on the photovoltaic shingle 10 in row R4. In some embodiments, the second power electronics units 50b is connected to the first electrical connector 30 of the photovoltaic shingle 10 in row R4. In some embodiments, the terminal 54a of the second power electronics unit 50b is connected to connector 34a of the first electrical connector 30 of the photovoltaic shingle 10 in row R4. In some embodiments, the second connector 38b of jumper wire 36c is connected to the terminal 54b of the second power electronics unit 50b, while the first connector 38a of the jumper wire 36c is connected to the connector 34a of the first electrical connector 30 of the photovoltaic shingle 10 in row R3. In some embodiments, the second connector 38b of jumper wire 36d is connected to the first connector 34a of the connector 30 in row R4, while the first connector 38a of the jumper wire 36d is connected to the second connector 34b of the connector 30 in row R3.

In some embodiments, the terminal 54c of the first power electronics unit 50a is electrically connected to terminal 54d of the second power electronics unit 50b. In some embodiments, the terminal 54c of the first power electronics unit 50a is electrically connected to terminal 54d of the second power electronics unit 50b by a jumper wire 56. In some embodiments, the terminal 54d of the first power electronics unit 50a is electrically connected to the connector 44b of the second electrical connector 40. In some embodiments, the terminal 54d of the first power electronics unit 50a is electrically connected to the connector 44b of the second electrical connector 40 by a jumper wire 58. In some embodiments, the terminal 54c of the second power electronics unit 50b is electrically connected to the connector 44a of the second electrical connector 40. In some embodiments, the terminal 54c of the second power electronics unit 50b is electrically connected to the connector 44a of the second electrical connector 40 by a jumper wire 60. In some embodiments, the first power electronics unit 50a is electrically connected to the second power electronics unit 50b. In some embodiments, it should be understood that the roofing system may have more or less than four of the rows R1-R4 of the photovoltaic shingles 10, and, therefore, the configuration of the power electronics units 50a-b, the electrical connectors 30, 40 and wires 36a-d, 56, 58, 60 would be modified accordingly.

In some embodiments, any or all of the power electronics units 50a-b, the electrical connectors 30, 40 and wires 36a-d, 56, 58, 60 may be installed by an installer on the roof deck 75. In some embodiments, any or all of the power electronics units 50a-b, the electrical connectors 30, 40 and wires 36a-d, 56, 58, 60 may be prefabricated prior to installation by an installer on the roof deck 75. In some embodiments, at least two of the photovoltaic shingles 10 are mechanically attached to one another and to a common headlap portion using adhesives, bonding or thermal welding processes. In some embodiments, the power electronics units 50a-b and applicable ones of the wires 36a-d, 56, 58, 60 are attached to the photovoltaic shingles 10 that are on the common headlap portion.

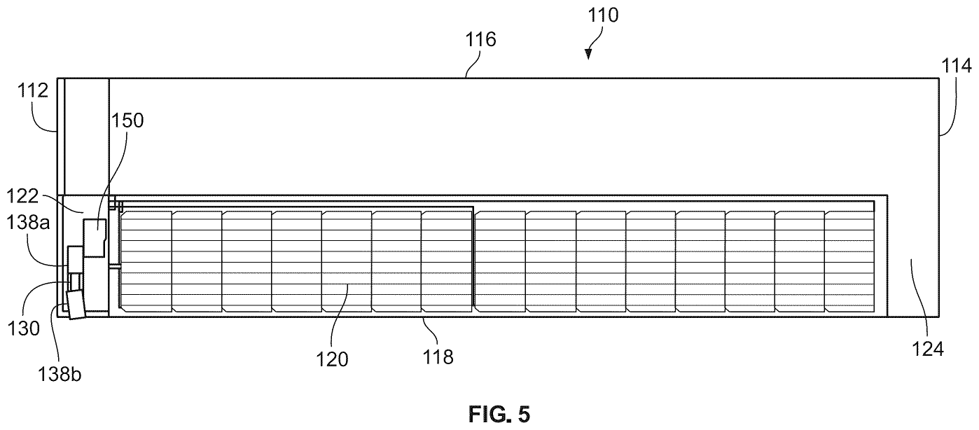

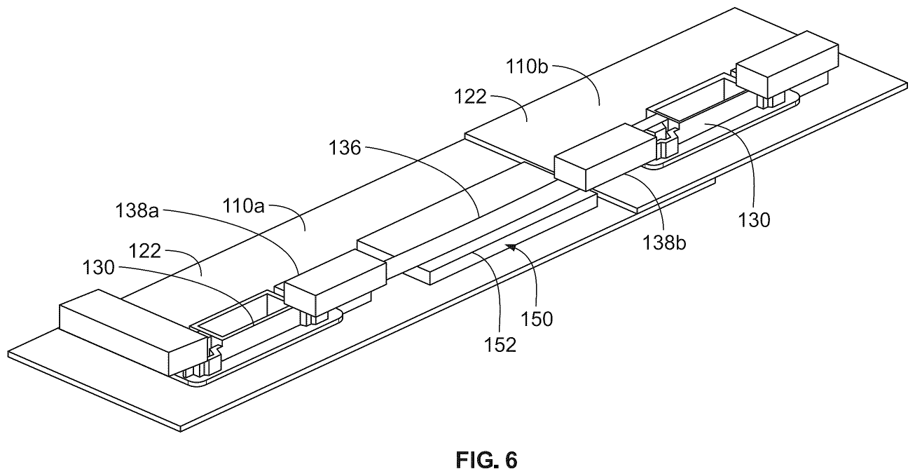

Referring to FIGS. 5 through 7, in some embodiments, a photovoltaic shingle 110 includes a first end 112, a second end 114 opposite the first end 112, a headlap portion 116, a reveal portion 118 including at least one solar cell 120, a first side lap portion 122 at the first end 112, and a second side lap portion 124 at the second end 114. In some embodiments, the at least one solar cell 120 includes a plurality of solar cells 120. In some embodiments, a first electrical connector 130 is on the first side lap portion 122. In some embodiments, the first electrical connector 130 is electrically connected to the plurality of solar cells 120. In some embodiments, a jumper wire 136 includes a first connector 138a at a first end thereof and second connector 138b at a second end thereof opposite the first end. In some embodiments, the first connector 138a is connected to the first electrical connector 130 of a first photovoltaic shingle 110a and the second connector 138b is connected to the first electrical connector 130 of a second photovoltaic shingle 110b. In some embodiments, the photovoltaic shingle 110 includes a power electronics unit 150 on the first side lap portion 122. In some embodiments, the power electronics unit 150 is proximate to the first electrical connector 130. In some embodiments, the power electronics unit 150 is electrically connected to the first electrical connector 130. In some embodiments, the power electronics unit 150 includes a housing 152 and power electronics within the housing 152. In some embodiments, the power electronics include an optimizer, a bypass diode, system monitoring electronic components, a rapid shutdown device, or electronic communication components. In some embodiments, the photovoltaic shingle 110 and/or one or more of the foregoing components thereof has a structure, function, composition and/or features similar to those of the photovoltaic shingle 10 and the respective components thereof.

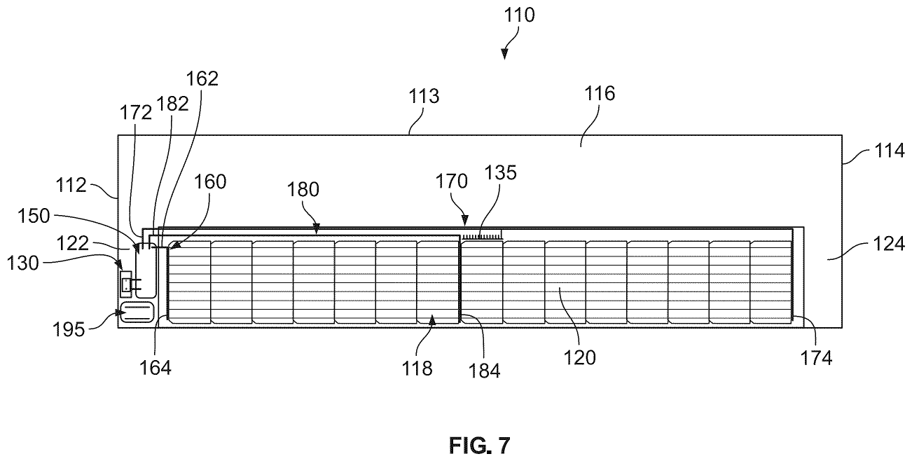

Referring to FIG. 7, in some embodiments, the photovoltaic shingle 110 includes a first bussing 160. In some embodiments, the first bussing 160 is located proximate to the first end 112. In some embodiments, the first bussing 160 includes a first end 162 electrically connected to the power electronics unit 150 and a second end 164 proximate to the first end 112 of the photovoltaic shingle 110 and electrically connected to the solar cells 120.

In some embodiments, the photovoltaic shingle 110 includes a second bussing 170. In some embodiments, the second bussing 170 includes a first end 172 electrically connected to the power electronics unit 150 and a second end 174 proximate to the second end 114 of the photovoltaic shingle 110 and electrically connected to the solar cells 120.

In some embodiments, the photovoltaic shingle 110 includes a third bussing 180. In some embodiments, the third bussing 180 includes a first end 182 electrically connected to the power electronics unit 150 and a second end 184 between the first end 112 and the second end 114 of the photovoltaic shingle 110 and electrically connected to the solar cells 120.

In some embodiments, the photovoltaic shingle 110 includes at least one bypass diode 135. In some embodiments, the at least one bypass diode 135 is electrically connected to the second bussing 170. In some embodiments, the at least one bypass diode includes a plurality of bypass diodes 135. In some embodiments, the at least one bypass diode 135 is located within a section of the photovoltaic shingle 110 that is located between an upper edge 113 of the photovoltaic shingle 110 and the plurality of solar cells 120.

In some embodiments, the photovoltaic shingle includes a bracket 195 on the first side lap portion 122. In some embodiments, the bracket 195 is configured to receive a cover. In some embodiments, the cover is a wire cover. In some embodiments, the first side lap portion 122 having the first electrical connector 130, the power electronics unit 150, the bracket 195 and the cover are part of a wireway.

In some embodiments, the bracket 195, the cover and the wireway include a structure, components, composition and/or function similar to those of more or one of the embodiments of the brackets, wireways and wire covers disclosed in PCT International Patent Publication No. WO 2022/051593, Application No. PCT/US2021/049017, published Mar. 10, 2022, titled “Building Integrated Photovoltaic System,” owned by GAF Energy LLC; U.S. Pat. No. 11,251,744 to Bunea et al., issued Feb. 15, 2022, titled “Photovoltaic Shingles and Methods of Installing Same, owned by GAF Energy LLC;” U.S. Pat. No. 11,870,227, issued Jan. 9, 2024, titled “Building Integrated Photovoltaic System,” owned by GAF Energy LLC; and/or U.S. Pat. No. 12,013,153 to Clemente et al., issued Jun. 18, 2024, titled “Building Integrated Photovoltaic System,” and owned by GAF Energy LLC, the disclosures of each of which are incorporated by reference herein in their entireties. In some embodiments, the bracket 195, the cover and the wireway include a structure, components, composition and/or function similar to those of more or one of the embodiments of the brackets, wireways and wire covers disclosed in U.S. Pat. No. 12,009,782 to West et al., issued Jun. 11, 2024, titled “Photovoltaic Systems with Wireways,” and owned by GAF Energy LLC, the disclosure of which is incorporated by reference herein in its entirety. In some embodiments, the bracket 195 is spaced from the power electronics unit 150 at a distance of 1 mm to 10 mm. In some embodiments, the bracket 195 is spaced from the power electronics unit 150 at a distance of 1 mm to 9 mm. In some embodiments, the bracket 195 is spaced from the power electronics unit 150 at a distance of 1 mm to 8 mm. In some embodiments, the bracket 195 is spaced from the power electronics unit 150 at a distance of 1 mm to 7 mm. In some embodiments, the bracket 195 is spaced from the power electronics unit 150 at a distance of 1 mm to 6 mm. In some embodiments, the bracket 195 is spaced from the power electronics unit 150 at a distance of 1 mm to 5 mm. In some embodiments, the bracket 195 is spaced from the power electronics unit 150 at a distance of 1 mm to 4 mm. In some embodiments, the bracket 195 is spaced from the power electronics unit 150 at a distance of 1 mm to 3 mm. In some embodiments, the bracket 195 is spaced from the power electronics unit 150 at a distance of 1 mm to 2 mm.

In some embodiments, the bracket 195 is spaced from the power electronics unit 150 at a distance of 2 mm to 10 mm. In some embodiments, the bracket 195 is spaced from the power electronics unit 150 at a distance of 2 mm to 9 mm. In some embodiments, the bracket 195 is spaced from the power electronics unit 150 at a distance of 2 mm to 8 mm. In some embodiments, the bracket 195 is spaced from the power electronics unit 150 at a distance of 2 mm to 7 mm. In some embodiments, the bracket 195 is spaced from the power electronics unit 150 at a distance of 2 mm to 6 mm. In some embodiments, the bracket 195 is spaced from the power electronics unit 150 at a distance of 2 mm to 5 mm. In some embodiments, the bracket 195 is spaced from the power electronics unit 150 at a distance of 2 mm to 4 mm. In some embodiments, the bracket 195 is spaced from the power electronics unit 150 at a distance of 2 mm to 3 mm.

In some embodiments, the bracket 195 is spaced from the power electronics unit 150 at a distance of 3 mm to 10 mm. In some embodiments, the bracket 195 is spaced from the power electronics unit 150 at a distance of 3 mm to 9 mm. In some embodiments, the bracket 195 is spaced from the power electronics unit 150 at a distance of 3 mm to 8 mm. In some embodiments, the bracket 195 is spaced from the power electronics unit 150 at a distance of 3 mm to 7 mm. In some embodiments, the bracket 195 is spaced from the power electronics unit 150 at a distance of 3 mm to 6 mm. In some embodiments, the bracket 195 is spaced from the power electronics unit 150 at a distance of 3 mm to 5 mm. In some embodiments, the bracket 195 is spaced from the power electronics unit 150 at a distance of 3 mm to 4 mm.

In some embodiments, the bracket 195 is spaced from the power electronics unit 150 at a distance of 4 mm to 10 mm. In some embodiments, the bracket 195 is spaced from the power electronics unit 150 at a distance of 4 mm to 9 mm. In some embodiments, the bracket 195 is spaced from the power electronics unit 150 at a distance of 4 mm to 8 mm. In some embodiments, the bracket 195 is spaced from the power electronics unit 150 at a distance of 4 mm to 7 mm. In some embodiments, the bracket 195 is spaced from the power electronics unit 150 at a distance of 4 mm to 6 mm. In some embodiments, the bracket 195 is spaced from the power electronics unit 150 at a distance of 4 mm to 5 mm.

In some embodiments, the bracket 195 is spaced from the power electronics unit 150 at a distance of 5 mm to 10 mm. In some embodiments, the bracket 195 is spaced from the power electronics unit 150 at a distance of 5 mm to 9 mm. In some embodiments, the bracket 195 is spaced from the power electronics unit 150 at a distance of 5 mm to 8 mm. In some embodiments, the bracket 195 is spaced from the power electronics unit 150 at a distance of 5 mm to 7 mm. In some embodiments, the bracket 195 is spaced from the power electronics unit 150 at a distance of 5 mm to 6 mm. In some embodiments, the bracket 195 is spaced from the power electronics unit 150 at a distance of 6 mm to 10 mm. In some embodiments, the bracket 195 is spaced from the power electronics unit 150 at a distance of 6 mm to 9 mm. In some embodiments, the bracket 195 is spaced from the power electronics unit 150 at a distance of 6 mm to 8 mm. In some embodiments, the bracket 195 is spaced from the power electronics unit 150 at a distance of 6 mm to 7 mm.

In some embodiments, the bracket 195 is spaced from the power electronics unit 150 at a distance of 7 mm to 10 mm. In some embodiments, the bracket 195 is spaced from the power electronics unit 150 at a distance of 7 mm to 9 mm. In some embodiments, the bracket 195 is spaced from the power electronics unit 150 at a distance of 7 mm to 8 mm. In some embodiments, the bracket 195 is spaced from the power electronics unit 150 at a distance of 8 mm to 10 mm. In some embodiments, the bracket 195 is spaced from the power electronics unit 150 at a distance of 8 mm to 9 mm. In some embodiments, the bracket 195 is spaced from the power electronics unit 150 at a distance of 9 mm to 10 mm.

In some embodiments, the bracket 195 is spaced from the power electronics unit 150 at a distance of 1 mm. In some embodiments, the bracket 195 is spaced from the power electronics unit 150 at a distance of 2 mm. In some embodiments, the bracket 195 is spaced from the power electronics unit 150 at a distance of 3 mm. In some embodiments, the bracket 195 is spaced from the power electronics unit 150 at a distance of 4 mm. In some embodiments, the bracket 195 is spaced from the power electronics unit 150 at a distance of 5 mm. In some embodiments, the bracket 195 is spaced from the power electronics unit 150 at a distance of 6 mm. In some embodiments, the bracket 195 is spaced from the power electronics unit 150 at a distance of 7 mm.

In some embodiments, the bracket 195 is spaced from the power electronics unit 150 at a distance of 8 mm. In some embodiments, the bracket 195 is spaced from the power electronics unit 150 at a distance of 9 mm. In some embodiments, the bracket 195 is spaced from the power electronics unit 150 at a distance of 10 mm.

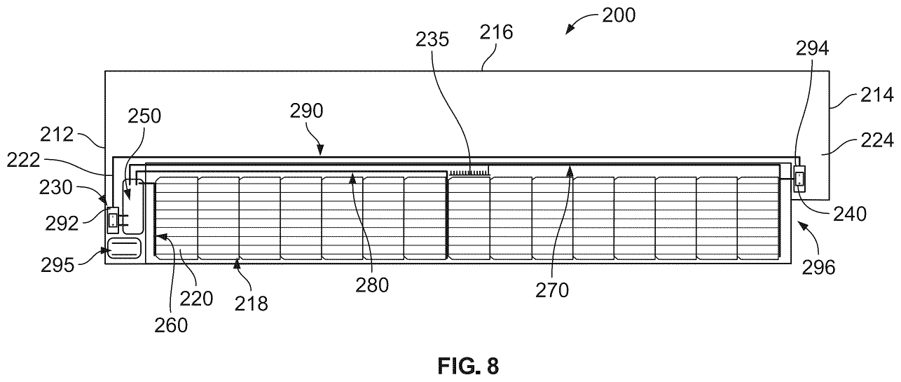

Referring to FIG. 8, in some embodiments, a jumper module 200 includes a first end 212, a second end 214 opposite the first end 212, a headlap portion 216, a reveal portion 218 including at least one solar cell 220, a first side lap portion 222 at the first end 212, and a second side lap portion 224 at the second end 214. In some embodiments, the at least one solar cell 220 includes a plurality of solar cells 220. In some embodiments, the jumper module 200 does not include any of the solar cells 220. In some embodiments, the jumper module 200 includes a structure, components, composition and/or function similar to that of the photovoltaic shingle 110, except as otherwise noted.

In some embodiments, the jumper module 200 includes a first electrical connector 230, a power electronics unit 250, and a bracket 295 on the first side lap portion 222. In some embodiments, one or more of the first electrical connector 230, the power electronics unit 250, and the bracket 295 includes a structure, components, composition and/or function similar to those of the corresponding first electrical connector 130, the power electronics unit 150, and the bracket 195 of the photovoltaic shingle 110.

In some embodiments, the jumper module 200 includes a first bussing 260, a second bussing 270, and a third bussing 280. In some embodiments, one or more of the first bussing 260, the second bussing 270, and the third bussing 280 includes a structure, components, composition and/or function similar to those of the corresponding first bussing 160, the second bussing 170, and the third bussing 180 of the photovoltaic shingle 110. In some embodiments, the jumper module 200 includes at least one bypass diode 235. In some embodiments, the at least one bypass diode 235 includes a structure, components, composition and/or function similar to those of the at least one bypass diode 135 of the photovoltaic shingle 110.

In some embodiments, the jumper module 200 includes a second electrical connector 240 on the second side lap portion 224 thereof. In some embodiments, the second electrical connector 240 is electrically connected to the first electrical connector 230 of the jumper module 200.

In some embodiments, the jumper module 200 includes a fourth bussing 290. In some embodiments, the fourth bussing 290 includes a first end 292 electrically connected to the first electrical connector 230 and a second end 294 electrically connected to the second electrical connector 240. In some embodiments, the second bussing 270 is electrically connected to the second electrical connector 240.

In some embodiments, the second side lap portion 224 of the jumper module 200 includes a notch 296. In some embodiments, the notch 296 is a cutout section of the second side lap portion 224. In some embodiments, the notch 296 has a rectangular shape. In some embodiments, the notch 296 has a square shape. In some embodiments, the notch 296 has a polygonal shape. In some embodiments, the notch 296 includes curved perimeter edges.

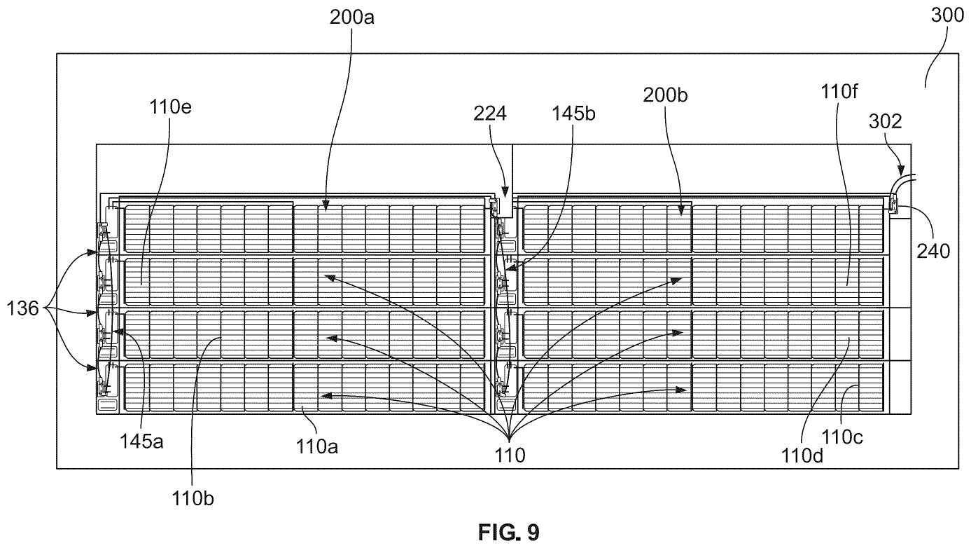

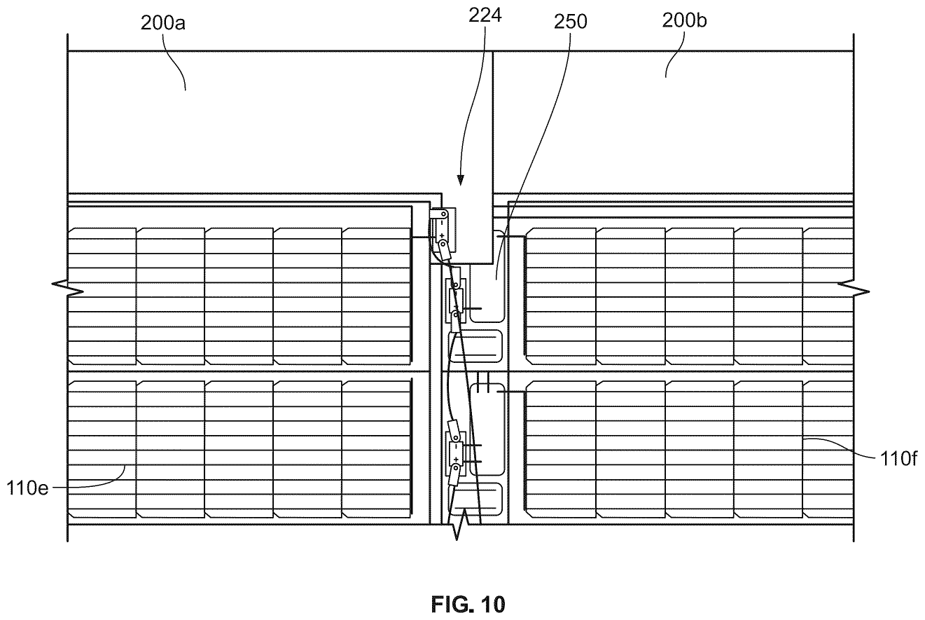

Referring to FIGS. 9 and 10, in some embodiments, a system includes a roof deck 300 of a structure and a plurality of the photovoltaic shingles 110 installed on the roof deck 300. In some embodiments, the photovoltaic shingles 110 are installed on a slope of the roof deck 300. In some embodiments, the system includes at least one of the jumper module 200. In some embodiments, the at least one of the jumper module 200 includes a plurality of the jumper modules 200.

In some embodiments, the plurality of photovoltaic shingles 110 includes at least first and second photovoltaic shingles 110a, 110b. In some embodiments, the first photovoltaic shingle 110a is vertically adjacent to the second photovoltaic shingle 110b. In some embodiments, the second photovoltaic shingle 110b overlays at least a part of the headlap portion 116 of the first photovoltaic shingle 110a. In some embodiments, the first electrical connector 130 of the first photovoltaic shingle 110a is electrically connected to the first electrical connector 130 of the second photovoltaic shingle 110b. In some embodiments, the first electrical connector 130 of the first photovoltaic shingle 110a is electrically connected to the first electrical connector 130 of the second photovoltaic shingle 110b by the jumper wire 136.

In some embodiments, the plurality of photovoltaic shingles 110 includes a third photovoltaic shingle 110c. In some embodiments, the third photovoltaic shingle 110c is horizontally adjacent to the first photovoltaic shingle 110a. In some embodiments, the first side lap portion 122 of the third photovoltaic shingle 110c overlays the second side lap portion 124 of the first photovoltaic shingle 110a.

In some embodiments, the plurality of photovoltaic shingles 110 includes a fourth photovoltaic shingle 110d. In some embodiments, the fourth photovoltaic shingle 110d is horizontally adjacent to the second photovoltaic shingle 110b. In some embodiments, the first side lap portion 122 of the fourth photovoltaic shingle 110d overlays the second side lap portion 124 of the second photovoltaic shingle 110b. In some embodiments, the fourth photovoltaic shingle 110d is vertically adjacent to the third photovoltaic shingle 110c. In some embodiments, the fourth photovoltaic shingle 110d overlays at least a part of the headlap portion 116 of the third photovoltaic shingle 110c. In some embodiments, the first electrical connector 130 of the third photovoltaic shingle 110c is electrically connected to the first electrical connector 130 of the fourth photovoltaic shingle 110d.

In some embodiments, a fifth photovoltaic shingle 110e is vertically adjacent to the second photovoltaic shingle 110b. In some embodiments, the fifth photovoltaic shingle 110e overlays at least a part of the headlap portion 116 of the second photovoltaic shingle 110b. In some embodiments, the first electrical connector 130 of the fifth photovoltaic shingle 110e is electrically connected to the first electrical connector 130 of the second photovoltaic shingle 110b.

In some embodiments, the plurality of photovoltaic shingles 110 includes a sixth photovoltaic shingle 110f. In some embodiments, the sixth photovoltaic shingle 110f is horizontally adjacent to the fifth photovoltaic shingle 110e. In some embodiments, the first side lap portion 122 of the sixth photovoltaic shingle 110f overlays the second side lap portion 124 of the fifth photovoltaic shingle 110e. In some embodiments, the sixth photovoltaic shingle 110f is vertically adjacent to the fourth photovoltaic shingle 110d. In some embodiments, the sixth photovoltaic shingle 110f overlays at least a part of the headlap portion 116 of the fourth photovoltaic shingle 110d. In some embodiments, the first electrical connector 130 of the sixth photovoltaic shingle 110f is electrically connected to the first electrical connector 130 of the fourth photovoltaic shingle 110d.

In some embodiments, a first jumper module 200a of the at least one jumper module 200 is vertically adjacent to the fifth photovoltaic shingle 110e. In some embodiments, the jumper module 200a overlays at least a part of the headlap portion 116 of the fifth photovoltaic shingle 110e. In some embodiments, the first electrical connector 230 of the jumper module 200a is electrically connected to the first electrical connector 130 of the fifth photovoltaic shingle 110e. In some embodiments, a column return cable 145a electrically connects the jumper module 200a and the first photovoltaic shingle 110a.

In some embodiments, a second jumper module 200b of the at least one jumper module 200 is vertically adjacent the sixth photovoltaic shingle 110f. In some embodiments, the jumper module 200b overlays at least a part of the headlap portion 116 of the sixth photovoltaic shingle 110f. In some embodiments, the first electrical connector 230 of the jumper module 200b is electrically connected to the first electrical connector 130 of the sixth photovoltaic shingle 110f. In some embodiments, a column return cable 145b electrically connects the jumper module 200b and the third photovoltaic shingle 110c.

In some embodiments, the second side lap portion 224 of the jumper module 200a overlays the first side lap portion 222 of the jumper module 200b. In some embodiments, the second side lap portion 224 of the jumper module 200a overlays the power electronics unit 250 of the jumper module 200b. In some embodiments, the second electrical connector 240 of the jumper module 200b is electrically connected to at least one home run electrical cable 302. In some embodiments, the at least one electrical cable 302 includes a plurality of electrical cables 302. In some embodiments, the at least one electrical cable 302 is electrically connected to an external electrical component, such as, for example, a combiner box, a DC disconnect unit, or an inverter.

In some embodiments, the plurality of photovoltaic shingles 110 and the corresponding array thereof may include more than the first through sixth photovoltaic shingles 110a, 110b, 110c, 110d, 110e, 110f. In some embodiments, the plurality of photovoltaic shingles 110 and the corresponding array thereof may include less than the first through sixth photovoltaic shingles 110a, 110b, 110c, 110d, 110e, 110f. In some embodiments, the system may include only the first through fourth photovoltaic shingles 110a, 110b, 110c, 110d and the jumper modules 200a, 200b, such that the jumper modules 200a, 200b would be installed above the photovoltaic shingles 110b, 110d accordingly. In some embodiments, the system may include only the jumper module 200a.

In some embodiments, a photovoltaic module includes a plurality of the photovoltaic shingles 110. In some embodiments, the plurality of photovoltaic shingles 110 is attached to a backsheet. In some embodiments, the plurality of photovoltaic shingles 110 overlay the backsheet. In some embodiments each of the plurality of photovoltaic shingles 110 is vertically stacked relative to one another on the backsheet. In some embodiments, the photovoltaic shingle 110 includes a headlap portion. In some embodiments, a portion of the backsheet forms the headlap portion. In some embodiments, the backsheet includes at least one layer. In some embodiments, the backsheet is composed of a polymeric material. In some embodiments, In some embodiments, the backsheet is composed of polyethylene terephthalate (“PET”). In some embodiments, the backsheet is composed of ethylene tetrafluoroethylene (“ETFE”). In some embodiments, the backsheet is composed of an acrylic such as polymethyl methacrylate (“PMMA”). In some embodiments, the backsheet is composed of thermoplastic polyolefin (TPO). In some embodiments, the backsheet is composed of a single ply TPO roofing membrane. In some embodiments, non-limiting examples of TPO membranes are disclosed in U.S. Pat. No. 9,359,014 to Yang et al., which is incorporated by reference herein in its entirety. In some embodiments, the backsheet is composed of polyvinyl chloride. In some embodiments, the backsheet is composed of ethylene propylene diene monomer (EPDM) rubber. In some embodiments, the backsheet includes a flame retardant additive. In some embodiments, the flame retardant additive may be clays, nanoclays, silicas, carbon black, metal hydroxides such as aluminum hydroxide, metal foils, graphite, and combinations thereof.

In some embodiments, the plurality of photovoltaic shingles 110 is attached to the backsheet. In some embodiments, the plurality of photovoltaic shingles 110 is attached to the backsheet by an adhesive. In some embodiments, the plurality of photovoltaic shingles 110 is attached to the backsheet by thermal bonding. In some embodiments, the plurality of photovoltaic shingles 110 is attached to the backsheet by ultrasonic welding. In some embodiments, the plurality of photovoltaic shingles 110 is attached to the backsheet by thermal welding. In some embodiments, the plurality of photovoltaic shingles 110 is attached to the backsheet by mechanical fasteners. In some embodiments, the fasteners may include nails, screws, rivets, or staples.

In some embodiments, the plurality of photovoltaic shingles 110 attached to the backsheet includes two of the photovoltaic shingles 110. In some embodiments, the plurality of photovoltaic shingles 110 attached to the backsheet includes three of the photovoltaic shingles 110. In some embodiments, the plurality of photovoltaic shingles 110 attached to the backsheet includes four of the photovoltaic shingles 110. In some embodiments, the plurality of photovoltaic shingles 110 attached to the backsheet includes five of the photovoltaic shingles 110. In some embodiments, the plurality of photovoltaic shingles 110 attached to the backsheet includes six of the photovoltaic shingles 110. In some embodiments, the plurality of photovoltaic shingles 110 attached to the backsheet includes more than six of the photovoltaic shingles 110.

The embodiments described herein are merely exemplary and that a person skilled in the art may make many variations and modifications without departing from the spirit and scope of the invention. All such variations and modifications are intended to be included within the scope of the invention.

1. A system, comprising:
a plurality of photovoltaic shingles installed on a slope of a roof deck,
wherein the plurality of photovoltaic shingles includes
at least a first photovoltaic shingle and a second photovoltaic shingle,
wherein the first photovoltaic shingle is vertically adjacent to the second photovoltaic shingle,
wherein each of the plurality of photovoltaic shingles includes:
a first end and a second end opposite the first end,
a plurality of solar cells arranged in at least one row,
a first electrical connector on the first side lap portion,
wherein the first electrical connector is adjacent to a first end of the at least one row of the plurality of solar cells,
wherein the first electrical connector is electrically connected to the plurality of solar cells, and
a power electronics unit
wherein the power electronics unit is electrically connected to the first electrical connector, and
wherein the first electrical connector of the first photovoltaic shingle is electrically connected to the first electrical connector of the second photovoltaic shingle.

2. The system of claim 1, wherein each of the plurality of photovoltaic shingles includes a first bussing located proximate to the first end, wherein the first bussing includes a first end electrically connected to the power electronics unit and a second end proximate to the first end of the photovoltaic shingle and electrically connected to the plurality of solar cells.

3. The system of claim 2, wherein each of the plurality of photovoltaic shingles includes a second bussing, wherein the second bussing includes a first end electrically connected to the power electronics unit and a second end proximate to the second end of the photovoltaic shingle and electrically connected to the plurality of solar cells.

4. The system of claim 3, wherein each of the plurality of photovoltaic shingles includes a third bussing, wherein the third bussing includes a first end electrically connected to the power electronics unit and a second end between the first and second ends of the photovoltaic shingles and electrically connected to the plurality of solar cells.

5. (canceled)

6. (canceled)

7. (canceled)

8. (canceled)

9. The system of claim 4, wherein the plurality of photovoltaic shingles includes a third photovoltaic shingle, and wherein the third photovoltaic shingle is horizontally adjacent to the first photovoltaic shingle.

10. (canceled)

11. The system of claim 9, wherein the plurality of photovoltaic shingles includes a fourth photovoltaic shingle, and wherein the fourth photovoltaic shingle is horizontally adjacent to the second photovoltaic shingle.

12. The system of claim 11, wherein the plurality of photovoltaic shingles includes a fifth photovoltaic shingle, and wherein the fifth photovoltaic shingle is vertically adjacent the second photovoltaic shingle and wherein the first electrical connector of the fifth photovoltaic shingle is electrically connected to the first electrical connector of the second photovoltaic shingle.

13. The system of claim 12, wherein the fifth photovoltaic shingle includes a second electrical connector at the second end thereof, and wherein the second electrical connector is electrically connected to the first electrical connector of the fifth photovoltaic shingle.

14. The system of claim 13, wherein the fifth photovoltaic shingle includes a fourth bussing, wherein the fourth bussing includes a first end electrically connected to the first electrical connector and a second end electrically connected to the second electrical connector.

15. The system of claim 14, wherein the second bussing of the fifth photovoltaic shingle is electrically connected to the second electrical connector of the fifth photovoltaic shingle.

16. (canceled)

17. (canceled)

18. (canceled)

19. The system of claim 1, wherein the power electronics unit includes a housing and power electronics within the housing, and wherein the power electronics includes an optimizer, a bypass diode, system monitoring electronic components, a rapid shutdown device, electronic communication components, or combinations thereof.

20. A system, comprising:
a plurality of photovoltaic shingles installed on a slope of a roof deck,
wherein the plurality of photovoltaic shingles includes
at least a first photovoltaic shingle and a second photovoltaic shingle,
wherein the first photovoltaic shingle is vertically adjacent to the second photovoltaic shingle,
wherein each of the plurality of photovoltaic shingles includes:
a first end and a second end opposite the first end,
a plurality of solar cells arranged in at least one row,
a first electrical connector,
wherein the first electrical connector is adjacent to a first end of the at least one row of the plurality of solar cells,
wherein the first electrical connector is electrically connected to the plurality of solar cells,
a power electronics unit,
wherein the power electronics unit is electrically connected to the first electrical connector,
a first bussing located proximate to the first end, wherein the first bussing includes a first end electrically connected to the power electronics unit and a second end proximate to the first end of the photovoltaic shingle and electrically connected to the plurality of solar cells;
a second bussing, wherein the second bussing includes a first end electrically connected to the power electronics unit and a second end proximate to the first end of the photovoltaic shingle and electrically connected to the plurality of solar cells,
wherein the first electrical connector of the first photovoltaic shingle is electrically connected to the first electrical connector of the second photovoltaic shingle.

21. The system of claim 1, wherein the first electrical connector has a thickness of 1 mm to 10 mm.

22. The system of claim 12, wherein the first electrical connector includes a housing, a first connector extending from the housing, and a second connector extending from the housing.

23. The system of claim 22, wherein the second connector of the first electrical connector of the first photovoltaic shingle is electrically connected to the first connector of the first electrical connector of the second photovoltaic shingle.

24. The system of claim 23, wherein the second connector of the first electrical connector of the first photovoltaic shingle is electrically connected to the first connector of the first electrical connector of the second photovoltaic shingle by a first electrical cable.

25. The system of claim 24, wherein the second connector of the first electrical connector of the second photovoltaic shingle is electrically connected to the first connector of the first electrical connector of the fifth photovoltaic shingle.

26. The system of claim 25, wherein the second connector of the first electrical connector of the second photovoltaic shingle is electrically connected to the first connector of the first electrical connector of the fifth photovoltaic shingle by a second electrical cable.

27. The system of claim 26, wherein the first connector of the first electrical connector of the first photovoltaic shingle is electrically connected to the second connector of the first electrical connector of the fifth photovoltaic shingle.

28. The system of claim 27, wherein the first connector of the first electrical connector of the first photovoltaic shingle is electrically connected to the second connector of the first electrical connector of the fifth photovoltaic shingle by a third electrical cable.

29. The system of claim 24, wherein the first connector of the first electrical connector of the first photovoltaic shingle is electrically connected to the second connector of the first electrical connector of the second photovoltaic shingle.

30. The system of claim 29, wherein the first connector of the first electrical connector of the first photovoltaic shingle is electrically connected to the second connector of the first electrical connector of the second photovoltaic shingle by a second electrical cable.
